(19) United States
(12) Patent Application Publication
(10) Pub. No.: US 2026/0100657 A1
(43) Pub. Date: Apr. 9, 2026

(54) NON-ISOLATED POWER CONVERSION APPARATUS BASED ON VIRTUAL ISOLATION

(71) Applicant: SEOUL NATIONAL UNIVERSITY R&DB FOUNDATION, Seoul (KR)

(72) Inventors: Jung-Ik HA, Seoul (KR); Dongsu LEE, Namyangju-si (KR); Juwon LEE, Seoul (KR)

(73) Assignee: SEOUL NATIONAL UNIVERSITY R&DB FOUNDATION, Seoul (KR)

(21) Appl. No.: 19/210,489

(22) Filed: May 16, 2025

(30) Foreign Application Priority Data
Oct. 4, 2024 (KR) 10-2024-0134611

(51) Int. Cl. H02M 7/25; H02M 1/00; H02M 1/12; H02M 1/44; H02M 7/219

(52) U.S. Cl. CPC H02M 7/25; H02M 1/007; H02M 1/123; H02M 1/44; H02M 7/219

(57) ABSTRACT

The non-isolated power conversion apparatus based on virtual isolation includes a filter unit provided with a common mode filtering function and a differential mode filtering function, a non-isolated AC-DC converter configured to convert an AC electrical signal output a first level of DC electrical signal, a non-isolated DC-DC converter configured to convert the first level of DC electrical signal into a second level of DC electrical signal, a grounding unit connected between the non-isolated DC-DC converter and a DC load, a grounding electrical signal measurement device configured to measure a grounding electrical signal or a common mode electrical signal of a system input terminal, and a grounding electrical signal controller configured to compare a grounding electrical signal measurement value with a set grounding electrical signal command and control an output of the non-isolated AC-DC converter and the non-isolated DC-DC converter so that the grounding electrical signal is reduced.

### CROSS-REFERENCE TO RELATED APPLICATION

This application claims priority to Korean Patent Application No. 10-2024-0134611 filed on Oct. 4, 2024, and all the benefits accruing therefrom under 35 U.S.C. § 119, the contents of which are incorporated by reference in their entirety.

### BACKGROUND

The present disclosure relates to a non-isolated power conversion apparatus based on virtual isolation. More specifically, the present disclosure relates to a non-isolated power conversion apparatus capable of implementing virtual isolation through reduction of ground current.

A power conversion apparatus is an apparatus that converts power into power having different voltages, currents, and frequencies, and is composed of power semiconductor devices and passive devices to perform AC (alternating current)-DC (direct current), DC-AC, and DC-DC power conversion. Recently, as the use of eco-friendly power energy is promoted in accordance with global climate policies, the demand for power conversion apparatuses is continuously increasing. In particular, as electric vehicles, new and renewable energy, and microgrids are emerging as key technologies, the frequency of use of AC-DC power conversion systems linked to an AC power system is increasing. In widely used AC-DC, DC-DC, and DC-AC power conversion apparatuses, ranging from user-contact devices at the level of several watts (W) to large power conversion apparatuses at the level of hundreds of kilowatts (kW), various topologies and control methods are used to freely adjust input and output voltage and current.

A differential mode component and a common mode component are applied to input and output ports of the power conversion apparatus. The differential mode component corresponds to a difference between components between ports, and the common mode component corresponds to the sum of the components. For example, when current flows into the (+) port of an apparatus input and current flows out of the (−) port thereof, power can be transferred due to a difference between the port current and port voltage. Typically, power transfer in the power conversion apparatus is accomplished through this differential mode component. On the other hand, the common mode component is defined when current flows into or out of the (+) port and (−) port of the apparatus input at the same time, and the current that flows thereinto in this way flows to the ground surface through an object or parasitic component in contact with the apparatus or is radiated as electromagnetic waves through space, forming a closed loop circuit including the apparatus and the ground surface.

Since the common mode component usually does not participate in power transfer and forms circulating currents and causes additional losses in the apparatus, or causes user stability and electromagnetic interference (EMI) problems, conventional power conversion apparatuses utilize transformers to secure a level of isolation. For a small-capacity adapter, a flyback converter is used, and for an automotive OBCs, an inductor-type isolated dual active bridge (DAB) converter, an isolated LLC converter, or the like is used. Using a transformer, galvanic isolation can be achieved, where a common mode path between a primary side and a secondary side thereof is blocked. Therefore, when using a transformer, the human body contact current and EMI problems caused by the common mode component can be theoretically solved.

However, since a parasitic capacitor exists between the primary side and secondary side of the transformer, high-frequency components above a switching frequency band can still flow through the transformer. Radiant or conductive electromagnetic waves generated by the common mode components of these high frequency components may cause malfunctions in wireless communication devices, and thus the International Electrotechnical Commission (IEC) limits the electromagnetic interference (EMI) of power conversion apparatuses, and typical power conversion apparatuses include EMI filters inside to meet these limitations. That is, in an isolated power conversion apparatus, the low-frequency common mode current of the system frequency band is blocked through galvanic isolation of the transformer and the high-frequency common mode current above the switching frequency band that is conducted through the parasitic components of the transformer is blocked through the EMI filter, and thus the leakage current and EMI components may be limited over the entire frequency range, ensuring the safety and electromagnetic compatibility for apparatus use.

However, the transformer used for isolation has the disadvantage of causing losses due to an energy conversion stage between electric energy and magnetic energy. Therefore, reducing or improving the power conversion stage by using a non-isolated converter without using a transformer to achieve galvanic isolation may be advantageous in terms of system efficiency and cost reduction. However, as described above, the EMI filters capable of blocking common mode components are used to regulate high-frequency components of the switching frequency band, and thus another method is needed to reduce common mode components of the system frequency band without a transformer in the non-isolated power conversion apparatus.

The common mode components of the system frequency band are divided into those due to the AC system and those due to the constitutional elements of the power conversion apparatus. The AC system has various ground potentials from a neutral point depending on a Y/A/V wiring method and a wiring grounding method, and may have common mode components due to the asymmetry of grounding method. Even if grounding of the AC system side is symmetrical, the AC system may have common mode components if AC system impedance or constitutional elements of the power conversion apparatus are configured asymmetrically. Even if the AC system configuration, AC system impedance, and power conversion apparatus are all configured symmetrically, the AC system may have common mode components of the system frequency band due to parameter errors, inverter nonlinearity, etc. Therefore, in order to satisfy the performance equivalent to isolation with a non-isolated converter, a method for effectively reducing common mode components of the system frequency band that occurs due to unspecified causes through active control is needed.

Non-isolated power conversion systems have been actively studied in fields such as solar energy and LED power supply, where high efficiency and low price are important, and the issue of reducing the common mode components mentioned above has come to the fore. In particular, due to the nature of solar energy generation systems, a large parasitic capacitor is formed between the ground and the solar panel, and this causes a problem in which a large common mode current, which causes a common mode current large enough to adversely affect overall system efficiency, flows and thus it is important to reduce the common mode components. Accordingly, topologies such as H5, H6, and HERIC and control methods thereof have been proposed to eliminate the common mode component that occurs during switching. However, although these topologies can reduce the common mode component of the switching band, the topologies still cannot cancel the common mode voltage that occurs due to asymmetric grounding, and the topologies have the limitation that only one-way power transfer is possible because the topologies cannot be used for rectification purposes other than as inverters.

Examples of related art include Korean registered patent publication No. 10-2282679 (Registration Date: Jul. 22, 2021, Title: Direct Electric Vehicle Charger) and Korean laid-open patent publication No. 10-2020-0075134 (Publication Date: Jun. 26, 2020, Title: Charging Device Capable of Reducing Low-Frequency Leakage Current).

### SUMMARY

The present disclosure provides a non-isolated power conversion apparatus based on virtual isolation that can efficiently and economically reduce a common mode component of a power system frequency band without using an isolated converter such as a transformer by implementing virtual isolation through ground current reduction.

In accordance with an exemplary embodiment of the present invention, a non-isolated power conversion apparatus based on virtual isolation includes a filter unit provided with a common mode filtering function for reducing common mode electromagnetic interference (EMI) noise generated by high frequency components of an AC power system and a differential mode filtering function for reducing ripple components generated due to switching, a non-isolated AC-DC converter configured to convert an AC electrical signal output by the filter unit into a first level of DC electrical signal, a non-isolated DC-DC converter configured to convert the first level of DC electrical signal into a second level of DC electrical signal, a grounding unit connected between the non-isolated DC-DC converter and a DC load, a grounding electrical signal measurement device configured to measure a grounding electrical signal of a grounding wire connecting the grounding unit and a ground terminal or a common mode electrical signal of a system input terminal, and a grounding electrical signal controller configured to compare a grounding electrical signal measurement value received from the grounding electrical signal measurement device with a set grounding electrical signal command and control an output of the non-isolated AC-DC converter and the non-isolated DC-DC converter so that the grounding electrical signal is reduced.

In the non-isolated power conversion apparatus based on virtual isolation, a neutral point of the filter unit may be connected to at least one of a DC link neutral point of the non-isolated AC-DC converter, a DC link neutral point of the non-isolated DC-DC converter, and a neutral point of the grounding unit.

In the non-isolated power conversion apparatus based on virtual isolation, the non-isolated DC-DC converter may be composed of two non-isolated DC-DC converters connected in a series symmetrical or parallel symmetrical manner.

In the non-isolated power conversion apparatus based on virtual isolation, when a TT grounding method in which a protective earth (PE) terminal and a system neutral point N are separated is applied to the non-isolated power conversion apparatus based on virtual isolation, the grounding electrical signal measurement device may be configured to measure a differential voltage between the system neutral point and the protective earth terminal and transmit the differential voltage to the grounding electrical signal controller, and the grounding electrical signal controller may be configured to control the output of the non-isolated AC-DC converter and the non-isolated DC-DC converter so that the differential voltage received from the grounding electrical signal measurement device becomes approximately 0, or control the output of the non-isolated AC-DC converter and the non-isolated DC-DC converter so that the common mode current received from the grounding electrical signal measurement device becomes approximately 0.

In the non-isolated power conversion apparatus based on virtual isolation, when a TN-C grounding method in which a protective earth (PE) terminal and a system neutral point N are connected is applied to the non-isolated power conversion apparatus based on virtual isolation, the grounding electrical signal measurement device may be configured to measure a ground current flowing through a grounding wire connected to the protective earth terminal and the system neutral point or a common mode current of the system input terminal and transfer the ground current or the common mode current to the grounding electrical signal controller, and the grounding electrical signal controller may be configured to control the output of the non-isolated AC-DC converter and the non-isolated DC-DC converter so that the ground current received from the grounding electrical signal measurement device becomes approximately 0.

### BRIEF DESCRIPTION OF THE DRAWINGS

Exemplary embodiments can be understood in more detail from the following description taken in conjunction with the accompanying drawings, in which:

FIG. 1 is a diagram showing a non-isolated power conversion apparatus based on virtual isolation in accordance with exemplary embodiment of the present invention;

FIG. 2 is a diagram exemplarily showing a method of reducing common mode components through non-isolated AC-DC converter control in accordance with an exemplary embodiment of the present invention;

FIG. 3 is a diagram exemplarily showing a method of reducing common mode components through non-isolated DC-DC converter control in accordance with an exemplary embodiment of the present invention;

FIG. 4 is a diagram exemplarily showing a method of reducing common mode components through non-isolated AC-DC converter control in a state where a non-isolated DC-DC converter is omitted in accordance with an exemplary embodiment of the present invention;

FIG. 5 is a diagram exemplarily showing a method of combining non-isolated DC-DC converters in a series symmetrical manner to reduce common mode voltage components in accordance with another exemplary embodiment of the present invention;

FIG. 6 is a diagram exemplarily showing a method of combining non-isolated DC-DC converters in a parallel symmetrical manner to reduce common mode voltage components in accordance with another exemplary embodiment of the present invention;

FIG. 7 is a diagram exemplarily showing a configuration of a grounding electrical signal controller for indirectly controlling ground current due to a non-isolated AC-DC converter through ground voltage control in accordance with another exemplary embodiment of the present invention;

FIG. 8 is a diagram exemplarily showing a configuration of a grounding electrical signal controller for indirectly controlling ground current due to a non-isolated DC-DC converter through ground voltage control in accordance with another exemplary embodiment of the present invention;

FIG. 9 is a diagram exemplarily showing a configuration of a grounding electrical signal controller for indirectly controlling ground current due to a non-isolated AC-DC converter and a non-isolated DC-DC converter through ground voltage control in accordance with another exemplary embodiment of the present invention;

FIG. 10 is a diagram exemplarily showing a configuration of a grounding electrical signal controller for directly controlling the ground current due to a non-isolated AC-DC converter in accordance with another exemplary embodiment of the present invention;

FIG. 11 is a diagram exemplarily showing a configuration of a grounding electrical signal controller for directly controlling ground current due to a non-isolated DC-DC converter in accordance with another exemplary embodiment of the present invention;

FIG. 12 is a diagram exemplarily showing the configuration of a grounding electrical signal controller for directly controlling ground current due to a non-isolated AC-DC converter and a non-isolated DC-DC converter in accordance with another exemplary embodiment of the present invention;

FIG. 13 is a diagram exemplarily showing a configuration for controlling ground current and input/output power of a single-phase non-isolated AC-DC converter in accordance with still another exemplary embodiment of the present invention;

FIG. 14 is a diagram exemplarily showing a configuration for controlling ground current and input/output power of a three-phase non-isolated AC-DC converter in accordance with still another exemplary embodiment of the present invention;

FIG. 15 is a diagram exemplarily showing a configuration for controlling ground current and input/output power of a non-isolated DC-DC converter in accordance with still another exemplary embodiment of the present invention;

FIG. 16 is a diagram exemplarily showing a method of measuring ground voltage in a three-phase system in which a protective earth (PE) terminal and a system neutral point N are separated in accordance with still another exemplary embodiment of the present invention;

FIG. 17 is a diagram showing a circuit for measuring ground voltage in accordance with still another exemplary embodiment of the present invention;

FIGS. 18 to 20 are diagrams exemplarily showing a method of measuring ground current in a three-phase system in which a protective earth terminal and a system neutral point are not separated in accordance with still another exemplary embodiment of the present invention;

FIGS. 21 to 23 are diagrams exemplarily showing a method of measuring ground current in a single-phase system in accordance with still another exemplary embodiment of the present invention;

FIG. 24 is a diagram showing a circuit for measuring ground current in accordance with still another exemplary embodiment of the present invention;

FIG. 25 is a diagram exemplarily showing a common mode circuit in a system in which a protective earth terminal and a system neutral point are separated in accordance with still another exemplary embodiment of the present invention; and

FIG. 26 is a diagram exemplarily showing a common mode circuit of a system in which the protective ground terminal and the system neutral point are not separated in accordance with still another exemplary embodiment of the present invention.

### DETAILED DESCRIPTION OF EMBODIMENTS

The specific structural or functional descriptions of the embodiments according to the concept of the present invention disclosed in this specification are merely exemplified for the purpose of describing the embodiments according to the concept of the present invention, and the embodiments according to the concept of the present invention may be implemented in various forms and are not limited to the embodiments described in this specification.

Since various modifications may be made to the embodiments according to the concept of the present invention and the embodiments may have various forms, the embodiments are exemplified in the drawings and described in detail in this specification. However, this is not intended to limit the embodiments according to the concept of the present invention to specific disclosed forms, and includes all modifications, equivalents, or substitutes included in the spirit and technical scope of the present invention.

Unless otherwise defined, all terms used herein, including technical or scientific terms, have the same meaning as commonly understood by a person of ordinary skill in the art to which the present invention belongs. Terms defined in commonly used dictionaries should be interpreted as having a meaning consistent with their meaning in the context of the relevant technology and will not be interpreted in an idealized or overly formal sense unless expressly defined otherwise in this specification.

When using a non-isolated AC-DC power conversion apparatus, as previously described in the section of BACKGROUND, common mode voltage of a system frequency band may be generated due to reasons such as asymmetry according to the system voltage and grounding method, a constant error of constitutional elements of a power conversion apparatus, offset voltage injection according to a PWM scheme, nonlinearity of a power conversion circuit, etc. In the existing AC-DC power conversion system, an isolated DC-DC converter is mainly used at a rear stage of an AC-DC converter for voltage and current control and galvanic isolation. If there is no isolation part in the system, the common mode voltage generated in the system passes through as it is, resulting in a leakage current. One embodiment of the present invention uses a non-isolated DC-DC converter instead of an isolated DC-DC converter, and reduces common mode components of the system through control.

Hereinafter, a preferred embodiment of the present invention will be described in detail with reference to the accompanying drawings.

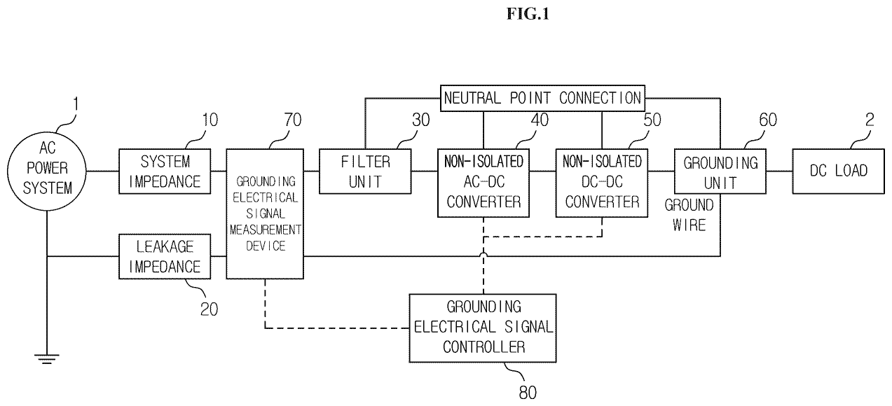

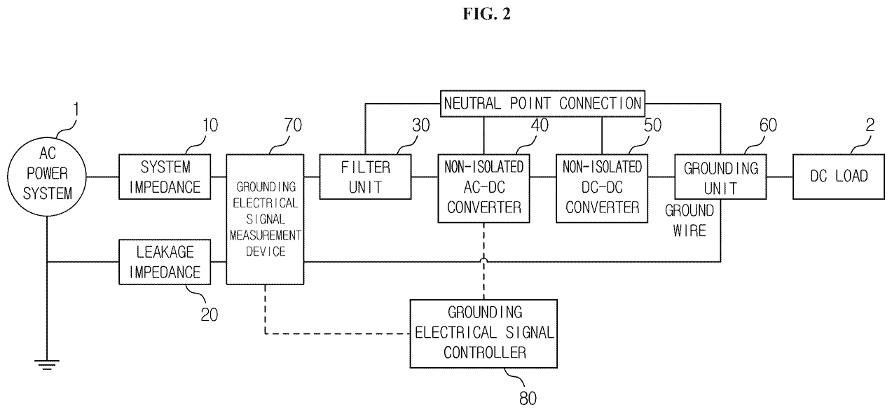

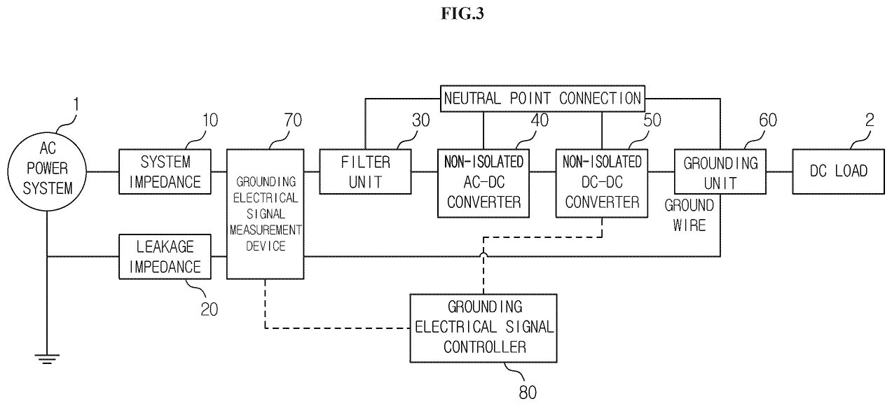

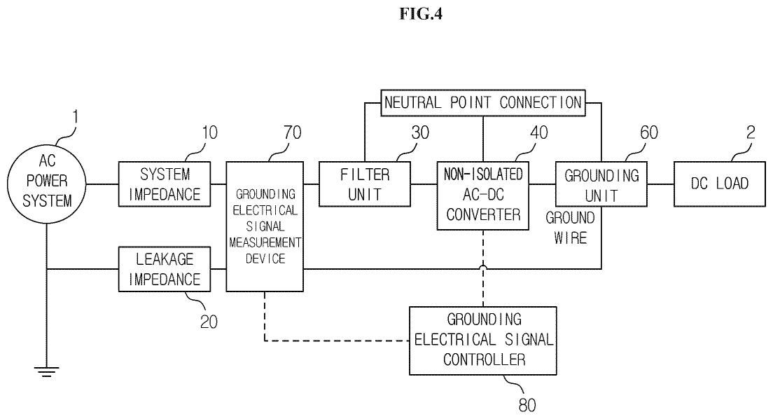

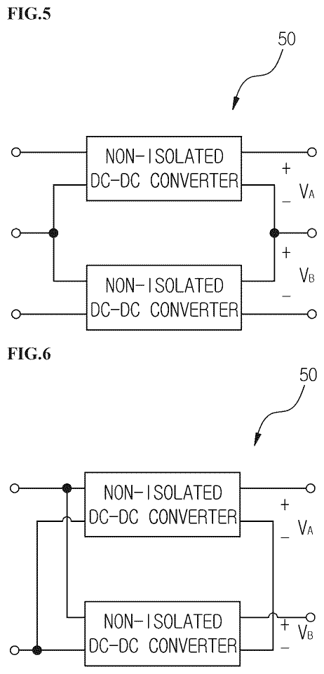

FIG. 1 is a diagram showing a non-isolated power conversion apparatus based on virtual isolation according to one embodiment of the present invention, FIG. 2 is a diagram exemplarily showing a method of reducing common mode components through non-isolated AC-DC converter 40 control in one embodiment of the present invention, FIG. 3 is a diagram exemplarily showing a method of reducing common mode components through non-isolated DC-DC converter 50 control in one embodiment of the present invention, FIG. 4 is a diagram exemplarily showing a method of reducing common mode components through the non-isolated AC-DC converter 40 control in a state where the non-isolated DC-DC converter 50 is omitted in one embodiment of the present invention, FIG. 5 is a diagram exemplarily showing a method of combining non-isolated DC-DC converters 50 in a series symmetrical manner to reduce common mode voltage components in one embodiment of the present invention, and FIG. 6 is a drawing exemplarily showing a method of combining the non-isolated DC-DC converters 50 in a parallel symmetrical manner to reduce common mode voltage components in one embodiment of the present invention.

Referring to FIGS. 1 to 6, a non-isolated power conversion apparatus based on virtual isolation according to one embodiment of the present invention may be configured to include a filter unit 30, the non-isolated AC-DC converter 40, the non-isolated DC-DC converter 50, a grounding unit 60, a grounding electrical signal measurement device 70, and a grounding electrical signal controller 80.

The filter unit 30 is provided with a common mode filtering function for reducing common mode electromagnetic interference EMI noise generated by high-frequency components of an AC power system 1 and a differential mode filtering function for reducing ripple components generated by switching. For example, the AC power system 1 may be a single-phase or three-phase system.

For example, a neutral point of the filter unit 30 may be configured to be connected to at least one of a DC link neutral point of the non-isolated AC-DC converter 40, a DC link neutral point of the non-isolated DC-DC converter 50, and a neutral point of the grounding unit 60. For example, when at least one of the neutral point of the filter unit 30, the neutral point of the AC-DC converter 40, the neutral point of the DC-DC converter 50, and the neutral point of the grounding unit 60 is connected, an impedance device such as a capacitor, an inductor, or a resistor may be connected in series between the neutral points.

For example, the filter unit 30 may be configured as a passive element circuit using an inductor, a capacitor, and a resistor, but may include an active EMI filter that efficiently reduces common mode components by using not only active elements but also passive elements.

In addition, for example, the filter unit 30 may be formed by a combination of a common mode filter and a differential mode filter, and the common mode filter may reduce common mode EMI noise above the switching frequency, and the differential mode filter may reduce a phase current ripple component caused by switching.

The non-isolated AC-DC converter 40 converts an AC electrical signal output by the filter unit 30 into a first level of DC electrical signal.

A method of reducing the common mode components through control in the non-isolated AC-DC converter 40 is exemplarily described as follows.

For example, in the non-isolated AC-DC converter 40, active power and reactive power can be controlled by utilizing a topology in which two switches are bridge-structured in one phase. Alternatively, the non-isolated AC-DC converter 40 may use a topology that has a multi-level output using three or more switches. In this case, a high-frequency common mode voltage may be generated by PWM switching of the non-isolated AC-DC converter 40. In this case, since only the differential mode component is involved in the power transfer of the non-isolated AC-DC converter 40 and the common mode component is not involved in the power transfer at all, the degree of freedom for the common mode voltage may be secured when synthesizing the voltages using PWM.

The common mode voltage vcm generated in the non-isolated AC-DC converter 40 may be derived as in

$${υ}_{c m} = \frac{{\sum }_{k = 1}^{{N}_{{υ}^{k}}^{k}} {υ}_{k 0}}{{N}_{p h}} \qquad [ Equation 1 ]$$

In Equation 1, Nₚₕ is the number of phases, and νₖₒ is the voltage between each phase and a neutral point. An instantaneous value of the common mode voltage appears in the form of harmonics of the switching frequency, and if this is assumed as one PWM, the desired common mode voltage command (average value) can be synthesized. For example, in order to expand an output voltage range, the non-isolated AC-DC converter 40 and the non-isolated DC-DC converter 50 may be connected in two stages and used, and the non-isolated AC-DC converter 40 that is not formed in a two-stage structure may also be used alone. In this case, the common mode voltage component may be reduced by using only the non-isolated AC-DC converter 40.

In one embodiment of the present invention, the common mode voltage of the non-isolated AC-DC converter 40 is utilized to reduce the common mode component of a system frequency band. For example, a common mode voltage command of the non-isolated AC-DC converter 40 is generated by the grounding electrical signal controller 80, and the common mode voltage may be synthesized in a non-isolated AC-DC converter in the form of PWM, which will be described below.

The non-isolated DC-DC converter 50 converts a first level of DC electrical signal received from the non-isolated AC-DC converter 40 into a second level of DC electrical signal.

A method of reducing the common mode component through control in the non-isolated DC-DC converter 50 is illustratively described as follows.

As previously described, for example, the common mode component of the system frequency band may occur due to reasons such as AC system configuration, AC system impedance 10 and parameter error, offset voltage injection according to the PWM scheme, inverter nonlinearity, etc. In order to reduce this common mode component) by using the non-isolated DC-DC converter 50 instead of an insulated DC-DC converter, the following topology is proposed. That is, for example, the non-isolated DC-DC converter 50 may be composed of two non-isolated DC-DC converters connected in a series symmetrical or parallel symmetrical manner.

In order to control the common mode component and differential mode component of the non-isolated DC-DC converter 50, an output may be configured using two non-isolated DC-DC converters.

As illustrated in FIGS. 5 and 6, two non-isolated DC-DC converters may be connected in parallel or series, and in each case, the differential and common mode components of the output are shown in Table 1 below based on a neutral point at a front stage of the DC-DC converter.

TABLE 1

| | Common | Differential |
|---|---|---|
| | mode voltage | mode voltage |
| Serial Symmetry | $\frac{{υ}_{A} - {υ}_{B}}{2}$ | υ_{A} + υ_{B} |
| Parallel Symmetry | $\frac{{υ}_{A} + {υ}_{B}}{2}$ | υ_{A} − υ_{B} |

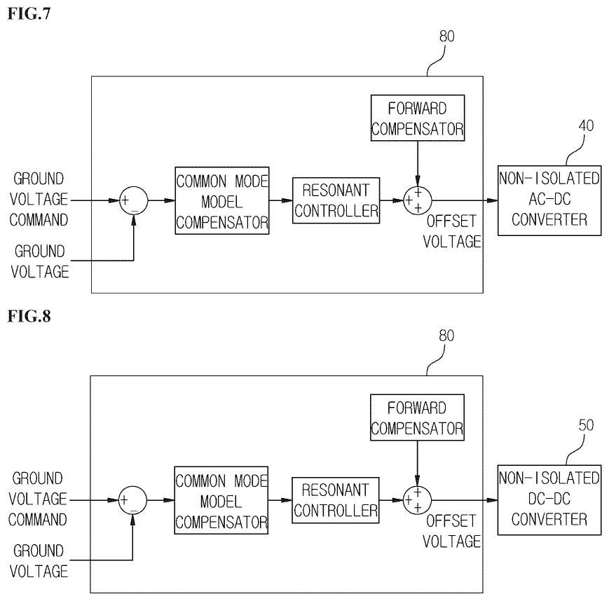

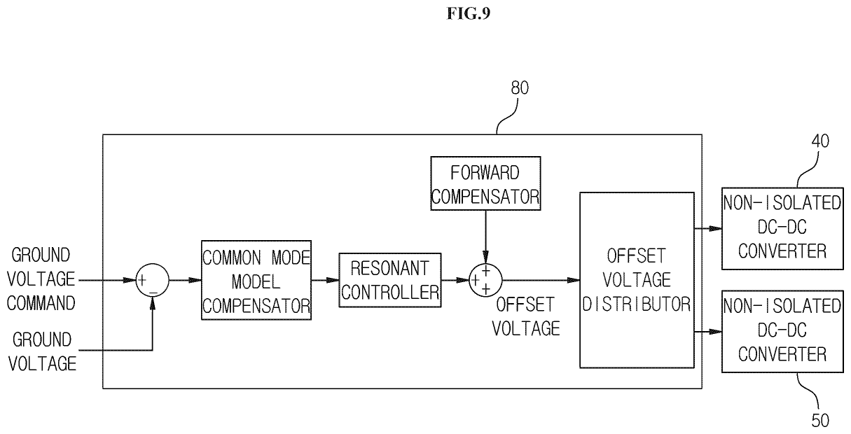

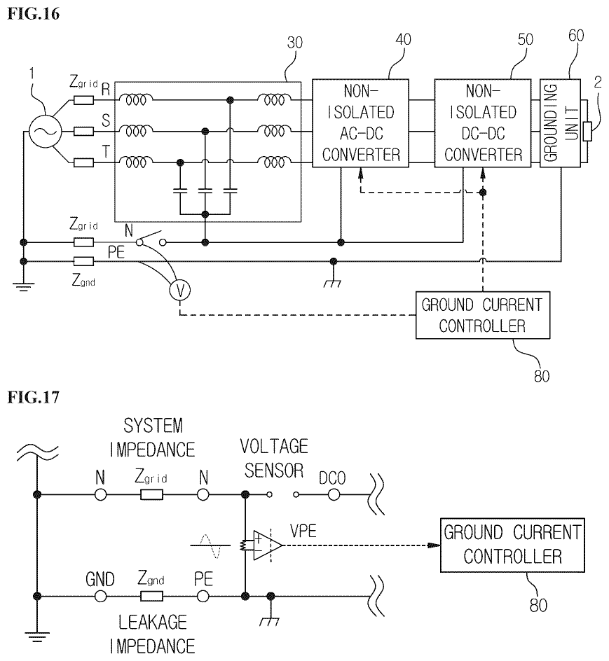

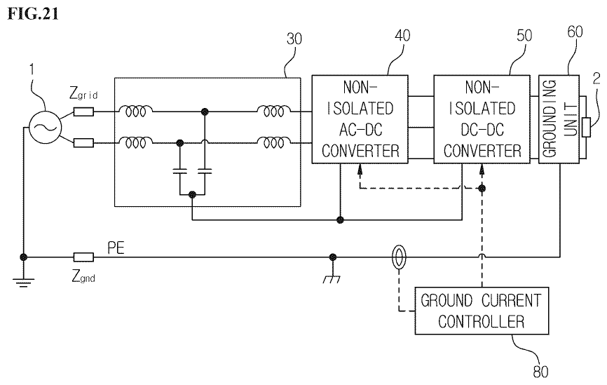

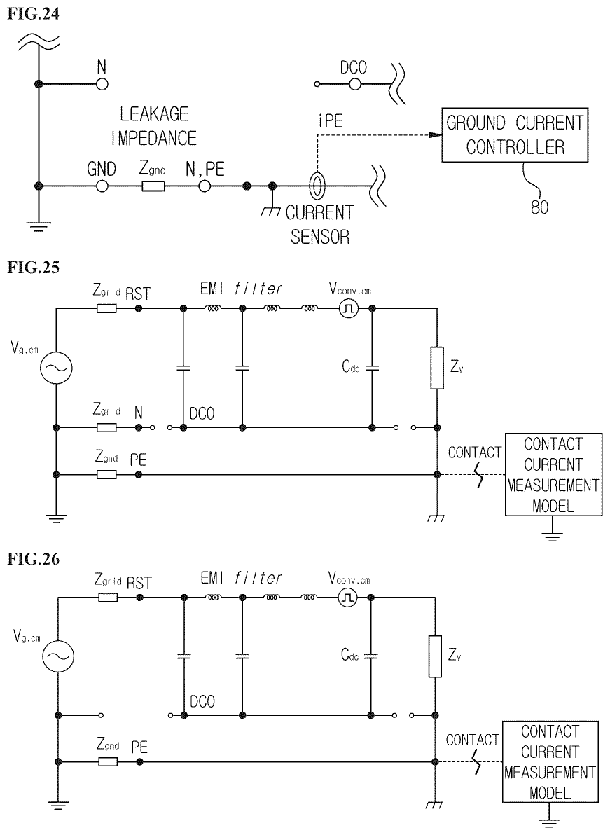

The control method is connected to the rear stage of the AC-DC converter connected to the single-phase/three-phase system and may be applied regardless of the system type, and may synthesize the common mode voltages generated for the reasons described above to a magnitude as shown in Table 1 and cancel each other out. A configuration for generating common and differential mode voltage commands by the grounding electrical signal controller 80 will be described below with reference to FIGS. 7 to 15, and a method of measuring voltage and current used as the input of the grounding electrical signal controller 80 will be described below with reference to FIGS. 16 to 26.

The grounding unit 60 is connected between the non-isolated DC-DC converter 50 and a DC load 2.

The grounding electrical signal measurement device 70 measures a grounding electrical signal of a grounding wire connecting the grounding unit 60 and a ground terminal or measures a common mode grounding electrical signal of the input terminal and transmits the measured grounding electrical signal to the grounding electrical signal controller 80.

The grounding electrical signal controller 80 compares the grounding electrical signal measurement value received from the grounding electrical signal measurement device 70 with a set grounding electrical signal command and controls the output of the non-isolated AC-DC converter 40 and the non-isolated DC-DC converter 50 so that the grounding electrical signal is reduced.

For example, a ground current control technique that directly measures ground voltage or ground current and feeds the ground voltage or ground current back will be exemplarily described with additional reference to FIGS. 7 to 15 as follows.

For example, a plant of the entire system including the non-isolated AC-DC converter 40, the non-isolated DC-DC converter 50, the filter unit 30, and the system described above can be derived, and the grounding electrical signal controller 80 may be configured using this. For example, the grounding electrical signal controller 80 that reduces the ground current may reduce the ground current using a method of indirectly reducing the ground current by measuring the ground voltage and a method of reducing the ground current by directly measuring the ground current. Details on the ground current or ground voltage measurement method will be described below.

For example, when the ground voltage is used as input, the grounding electrical signal controller 80 that indirectly controls the ground current by using the ground voltage may be configured. A case of controlling the non-isolated AC-DC converter 40 using the grounding electrical signal controller 80 is exemplified in FIG. 7, and a case of controlling the non-isolated DC-DC converter 50 is exemplified in FIG. 8. That is, FIG. 7 exemplarily shows the configuration of the grounding electrical signal controller 80 that indirectly controls the ground current through ground voltage control using the non-isolated AC-DC converter 40, and FIG. 8 exemplarily shows the configuration of the grounding electrical signal controller 80 that indirectly controls the ground current through ground voltage control using the non-isolated DC-DC converter 50. In addition, in FIG. 8, a case in which the non-isolated AC-DC converter 40 and the non-isolated DC-DC converter 50 are controlled using an offset voltage divider is exemplified.

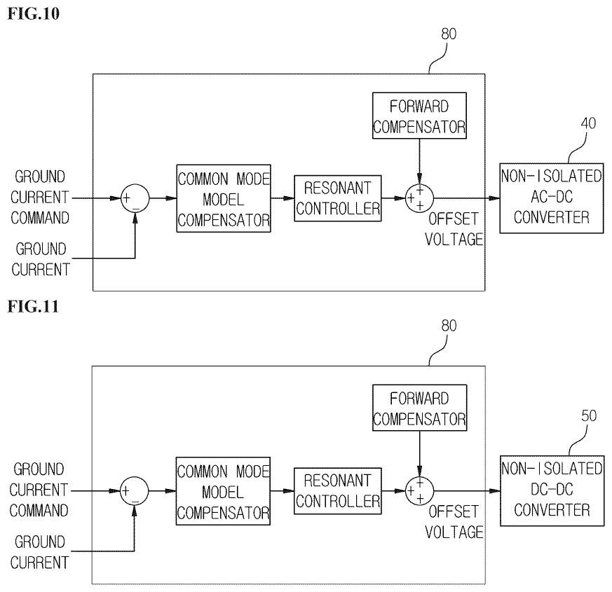

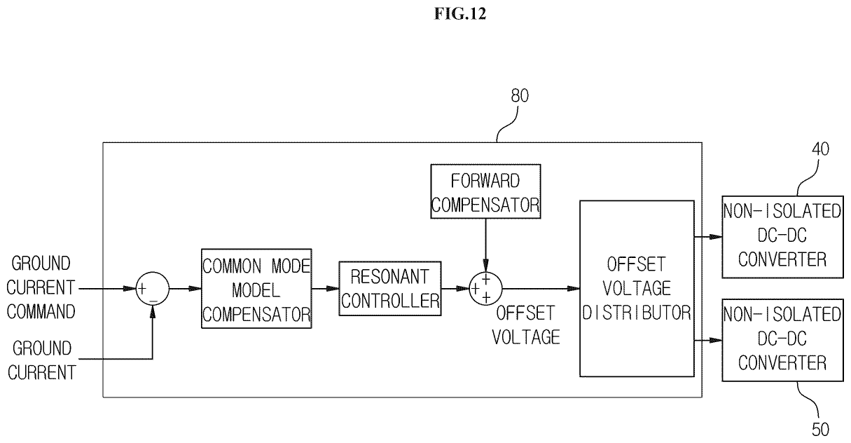

For example, when using the ground current as input, a controller that directly controls ground current can be configured using the ground current. A case of controlling the non-isolated AC-DC converter 40 using the grounding electrical signal controller 80 is exemplified in FIG. 10 and a case of controlling the non-isolated DC-DC converter 50 is exemplified in FIG. 11. That is, FIG. 10 exemplarily shows the configuration of the grounding electrical signal controller 80 that directly controls the ground current using the non-isolated AC-DC converter 40, and FIG. 11 exemplarily shows the configuration of the grounding electrical signal controller 80 that directly controls the ground current using the non-isolated DC-DC converter 50. In addition, in FIG. 12, a case of in which the non-isolated AC-DC converter 40 and the non-isolated DC-DC converter 50 are controlled using an offset voltage divider is exemplified.

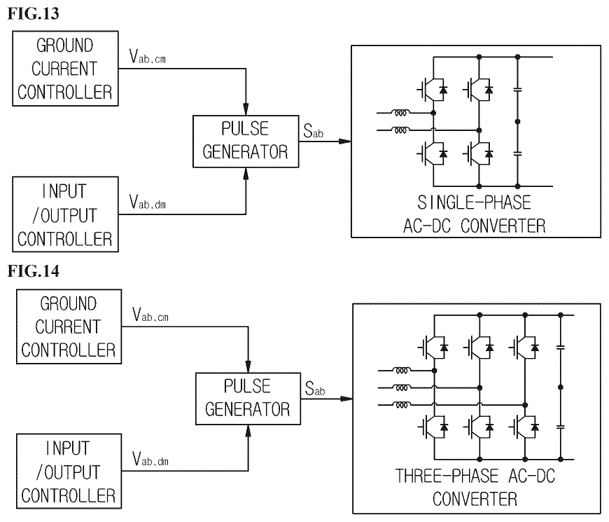

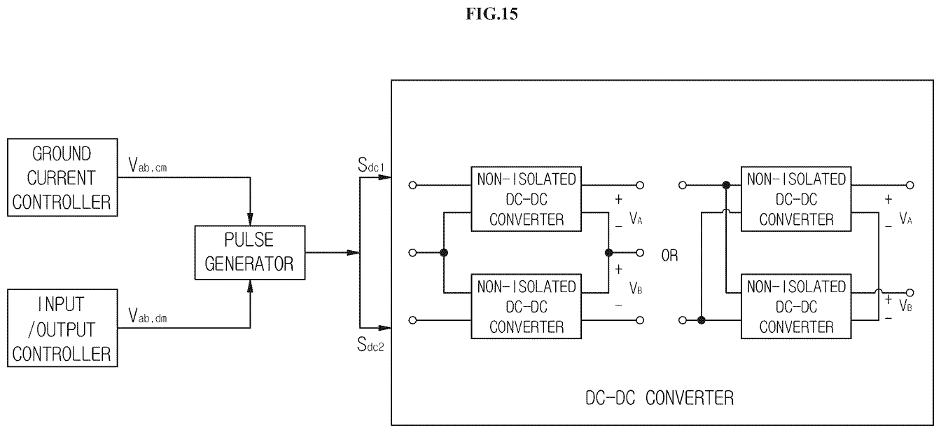

FIG. 13 is a diagram exemplarily showing a configuration for controlling ground current and input/output power of a single-phase non-isolated AC-DC converter 40, FIG. 14 is a diagram exemplarily showing a configuration for controlling ground current and input/output power of a three-phase non-isolated AC-DC converter 40, and FIG. 15 is a diagram exemplarily showing a configuration for controlling ground current and input/output power of the non-isolated DC-DC converter 50.

Referring to FIGS. 13 to 15 additionally, the ground current of the system frequency band can be controlled to 0 through the ground electrical signal controller 80 while independently controlling the input/output power. The grounding electrical signal controller 80 and the input/output power controller may generate common mode voltage and differential mode voltage commands, respectively, and may synthesize voltages by utilizing the non-isolated AC-DC converter 40 or the non-isolated DC-DC converter 50 described above. The synthesized voltage may be implemented to control a switching operation of the power conversion apparatus through a pulse generator.

For example, the grounding electrical signal controller 80 exemplified in FIGS. 7 to 12 may be designed based on a transfer function derived through a common mode equivalent circuit. For example, first, the plant is compensated by utilizing an inverse function of a common mode circuit transfer function. Next, a function generator is used to create a shape of a closed-loop transfer function of the grounding electrical signal controller 80. In order to configure the closed-loop transfer function in the form of a band-pass filter, the function generator may be configured as in Equation 2.

$${F}_{c} = {K}_{c} \times \frac{2 {ω}_{c}}{{s}^{2} + 2 {ω}_{c} s + {ω}_{o}^{2}} \qquad [ Equation 2 ]$$

In Equation 2, is a bandwidth and is a center frequency. Since the feedback ground voltage or ground current is an AC component having a minimum system frequency (approximately 50 to approximately 60 Hz) component, a low-frequency node frequency of the band-pass filter is placed at the frequency of the AC system, and a high-frequency node frequency is set to approximately 1/10 of the maximum switching frequency so as not to be affected by the switching frequency. Finally, if the user knows the symmetry/asymmetry of the AC system and the grounding method, a low-frequency common mode voltage generated resultantly from this may be forward-compensated.

For example, when controlling the common mode component through the non-isolated DC-DC converter 50 and injecting an offset voltage from the non-isolated AC-DC converter 40, the common mode component generated from the non-isolated AC-DC converter 40 placed at the front stage may be used as the input of a forward compensator. The output of the grounding electrical signal controller 80, which has passed through the forward compensator, common mode model compensator, and function generator, is in the form of a common mode voltage, which can be output through PWM switching of the non-isolated AC-DC converter 40 or the non-isolated DC-DC converter 50.

Hereinafter, with additional reference to FIGS. 16 to 26, a neutral point connection and a ground voltage and ground current measurement technique according to a grounding method will be exemplarily described.

As an example, when a TN-S grounding method or TT grounding method in which a protective earth (PE) terminal and a system neutral point (N) are separated is applied to the non-insulated power conversion device based on virtual isolation, the grounding electrical signal measurement device 70 may be configured to measure a differential voltage between a system neutral point and a protective earth terminal and transmit the differential voltage to the grounding electrical signal controller 80 and the grounding electrical signal controller 80 may be configured to control the output of the non-insulated AC-DC converter 40 and the non-insulated DC-DC converter 50 so that the differential voltage received from the grounding electrical signal measurement device 70 approximately becomes 0.

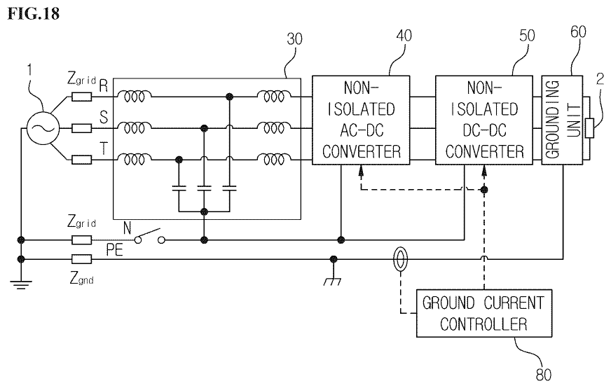

This configuration will be specifically and illustratively described with additional reference to FIGS. 16 and 17 as follows.

For example, when connecting the AC power system and the power conversion apparatus, in addition to the terminals (R, S, and T) for power transfer, the system neutral point N and protective earth (PE) terminal may also be connected depending on the grounding method of the system. In a three-phase system-connected system, when using the TT grounding method, the neutral point N and the protective earth (PE) terminal are connected to the power conversion apparatus, but when using the TN-C grounding method, only the protective earth (PE) terminal is connected thereto. In a single-phase system-connected system, the neutral point N may be sometimes connected to the terminal for power transfer, and the protective earth (PE) terminal is connected separately. Depending on the grounding method, the ground voltage or ground current can be measured, and the measured ground voltage or ground current may be used as feedback for the grounding electrical signal controller 80.

Referring to the example of FIG. 16, the ground voltage may be obtained by measuring the differential voltage between the system neutral point N and the protective ground (PE) terminal in the TT grounding method. In this case, the system neutral terminal N is separated from an LCL filter of the AC-DC power conversion apparatus, so that the neutral terminal voltage has the same potential as the ground voltage of the AC system. When the neutral terminal is separated from the power conversion apparatus, the differential voltage component of the neutral terminal and the protective ground terminal generates a ground current. That is, if the differential voltage is controlled to 0, the ground current is also reduced. In this case, the output of the grounding electrical signal controller 80 is output as a common mode voltage of the non-insulated AC-DC converter 40 or the non-insulated DC-DC converter. The advantage of the method of controlling the ground voltage is that it is relatively easy to measure the differential voltage. Since the neutral terminal and the protective ground terminal are necessarily exposed in the power conversion apparatus of the TT grounding method, the differential voltage can be simply measured using an isolated differential amplifier of IC chip type as illustrated in FIG. 17. However, since the ground current is indirectly reduced by utilizing the ground voltage, it is difficult to completely reduce the ground current to 0, and it may be affected by another power conversion apparatus connected to the neutral terminal of the AC power system.

As another example, in a case where a TN-C grounding method in which the Protective Earth (PE) terminal and the grid neutral point (N) are connected is applied to the non-isolated power conversion device based on virtual insulation, a configuration in which the output of the non-insulated AC-DC converter 40 and the non-insulated DC-DC converter 50 are controlled so that the grounding electrical signal measuring device 70 measures the grounding current flowing through the grounding wire connected to the protective earth terminal and the system neutral point or measures the common mode current of the input terminal and transmits the measured the grounding current or common mode current to the grounding electrical signal controller 80 and the grounding electrical signal controller 80 makes the grounding current received from the grounding electrical signal measuring device 70 zero.

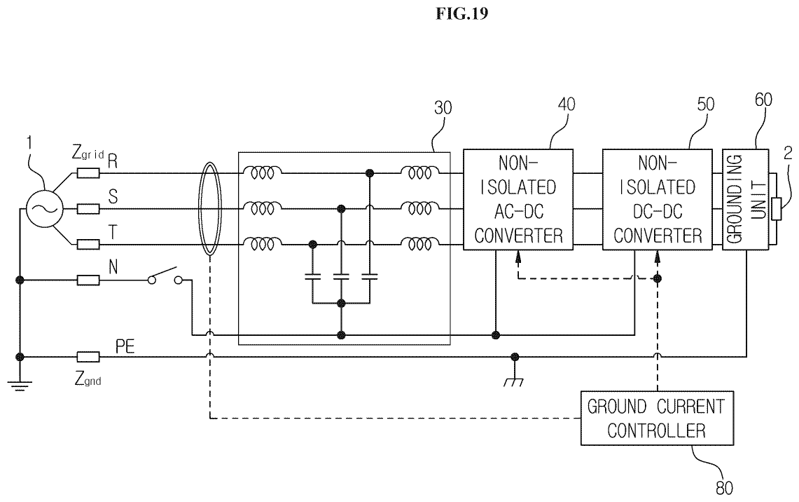

This configuration is specifically and exemplarily described with additional reference to FIGS. 18 to 24 as follows.

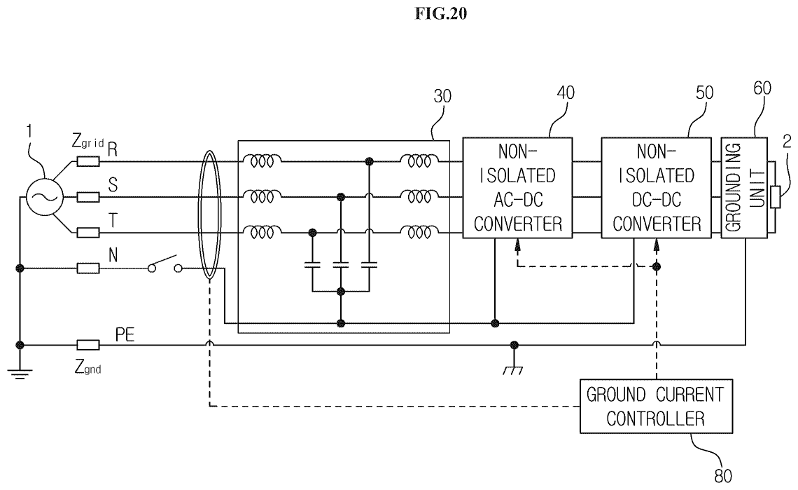

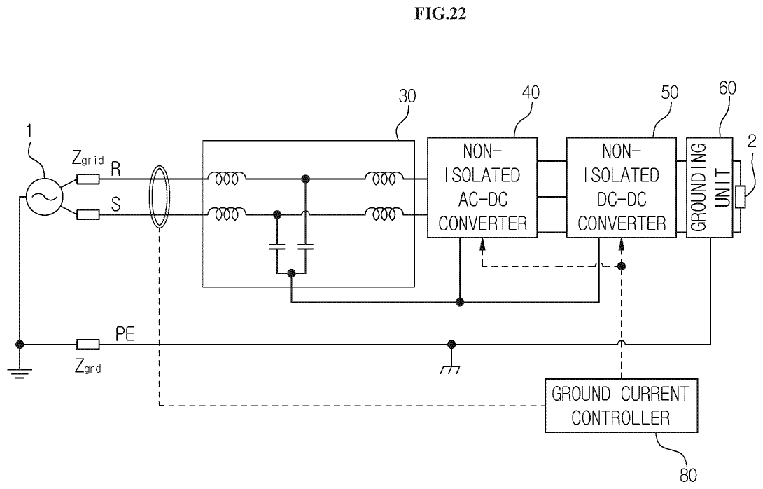

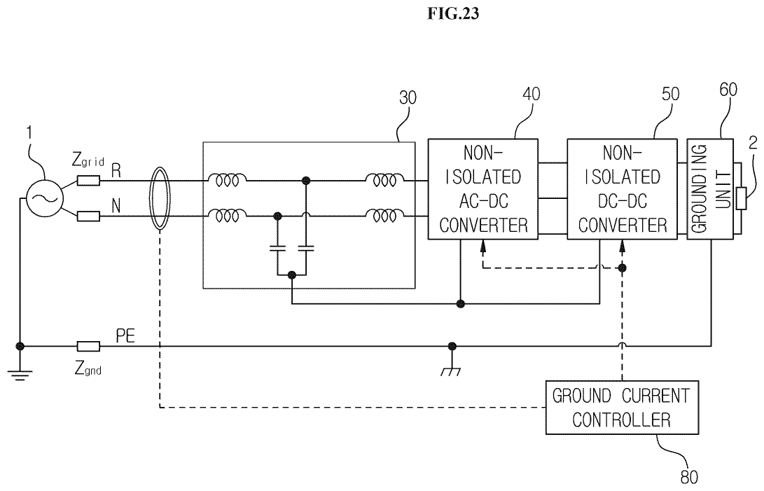

Referring to the examples of FIGS. 18 to 24, the ground current is directly measured in each of the three-phase system and the single-phase system, and is directly fed back to the grounding electric signal controller 80. In this case, the output of the grounding electric signal controller 80 is output as a common mode voltage of the non-insulated AC-DC converter 40 or the non-insulated DC-DC converter 50. According to this method, since the ground current is directly measured by a current sensor, the ground current can be utilized regardless of the grounding method (TT and TN) and the number of phases (three-phase and single-phase) of the AC system. In addition, since the ground current is directly controlled, the ground current can be reduced more effectively through a method of controlling the ground current to 0. In the case of FIG. 19, the ground current is measured by measuring the common mode current of the three-phase system input terminal and the measured ground current is directly fed back to the grounding electrical signal controller 80, in the case of FIG. 20, the ground current is measured by measuring the common mode current of the three-phase system input terminal and a neutral wire, and the measured ground current is directly fed back to the grounding electrical signal controller 80, in the case of FIG. 22, when the single-phase system input is composed of two pole voltages of the three-phase system, the ground current is measured by measuring the common mode current, and the measured ground current is directly fed back to the grounding electrical signal controller 80, and in the case of FIG. 23, when the single-phase system input is composed of one pole voltage and the neutral point of the three-phase system, the ground current is measured by measuring the common mode current, and measured ground current is directly fed back to the grounding electrical signal controller 80.

Next, referring to the examples of FIGS. 25 and 26, common mode circuits are configured according to grounding methods, respectively. In the TN grounding method system, as illustrated in FIG. 19, a floating EMI filter structure that separates the neutral point N of the AC system and the neutral point DCO of the DC link may be utilized. By utilizing this method, the high-frequency component of the common mode voltage ν_{conv,cm} generated by the power conversion apparatus is blocked from affecting the system, and the common mode current is reduced in the filter unit 30. In the TT grounding method, there is no separate neutral point terminal, and thus the floating EMI filter structure is naturally formed. In addition, the protective ground (PE) terminal of the system is separated by the common mode voltage ν_{conv,cm} of the power conversion apparatus and ground impedance Zy. On the other hand, it can be seen that the low-frequency common mode voltage ν_{g,cm} generated in the AC system directly affects the ground terminal.

As described in detail above, according to the present invention, an effect of providing a non-isolated power conversion apparatus based on virtual isolation that can efficiently and economically reduce the common mode components of the power system frequency band without using an isolated converter such as a transformer by implementing virtual isolation through ground current reduction is achieved.

Although the non-isolated power conversion apparatus based on virtual isolation has been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. A non-isolated power conversion apparatus based on virtual isolation comprising:
a filter unit provided with a common mode filtering function for reducing common mode electromagnetic interference (EMI) noise generated by high frequency components of an AC power system and a differential mode filtering function for reducing ripple components generated due to switching;
a non-isolated AC-DC converter configured to convert an AC electrical signal output by the filter unit into a first level of DC electrical signal;
a non-isolated DC-DC converter configured to convert the first level of DC electrical signal into a second level of DC electrical signal;
a grounding unit connected between the non-isolated DC-DC converter and a DC load;
a grounding electrical signal measurement device configured to measure a grounding electrical signal of a grounding wire connecting the grounding unit and a ground terminal or a common mode electrical signal of a system input terminal; and
a grounding electrical signal controller configured to compare a grounding electrical signal measurement value received from the grounding electrical signal measurement device with a set grounding electrical signal command and control an output of the non-isolated AC-DC converter and the non-isolated DC-DC converter so that the grounding electrical signal is reduced.

2. The non-isolated power conversion apparatus of claim 1, wherein a neutral point of the filter unit is connected to at least one of a DC link neutral point of the non-isolated AC-DC converter, a DC link neutral point of the non-isolated DC-DC converter, and a neutral point of the grounding unit.

3. The non-isolated power conversion apparatus of claim 1, wherein the non-isolated DC-DC converter is composed of two non-isolated DC-DC converters connected in a series symmetrical or parallel symmetrical manner.

4. The non-isolated power conversion apparatus of claim 1, wherein, when a TT grounding method in which a protective earth (PE) terminal and a system neutral point N are separated is applied to the non-isolated power conversion apparatus based on virtual isolation,
the grounding electrical signal measurement device is configured to measure a differential voltage between the system neutral point and the protective earth terminal and transmit the differential voltage to the grounding electrical signal controller, and
the grounding electrical signal controller is configured to control the output of the non-isolated AC-DC converter and the non-isolated DC-DC converter so that the differential voltage received from the grounding electrical signal measurement device approximately becomes 0, or control the output of the non-isolated AC-DC converter and the non-isolated DC-DC converter so that the common mode current received from the grounding electrical signal measurement device approximately becomes 0.

5. The non-isolated power conversion apparatus of claim 1, wherein, when a TN-C grounding method in which a protective earth (PE) terminal and a system neutral point N are connected is applied to the non-isolated power conversion apparatus based on virtual isolation,
the grounding electrical signal measurement device is configured to measure a ground current flowing through a grounding wire connected to the protective earth terminal and the system neutral point or a common mode current of the system input terminal and transfer the ground current or the common mode current to the grounding electrical signal controller, and
the grounding electrical signal controller is configured to control the output of the non-isolated AC-DC converter and the non-isolated DC-DC converter so that the ground current received from the grounding electrical signal measurement device approximately becomes 0.
